(19) United States
(12) Patent Application Publication
(10) Pub. No.: US 2003/0192499 A1
(43) Pub. Date: Oct. 16, 2003

(54) Self charging engine heater

(76) Inventor: Stephen W. Herren, East Helena, MT (US)

Correspondence Address: Glen F. Gallinger, 7420 Milner Dr., Colorado Springs, CO, 80920, US

(21) Appl. No.: 10/121,004

(22) Filed: Apr. 12, 2002

(51) Int. Cl. F02N 17/02

(52) U.S. Cl. 123/142.5 E

(57) ABSTRACT

In cold weather the inconvenience of plugging in a motor vehicle to ensure starting and warmer starts is generally considered well worth the effort. This inconvenience includes monitoring the weather to anticipate cold nights, and plugging the motor vehicle into power on cold nights to ensure smooth starts on following mornings. This inconvenience also includes passing up potential parking locations where an adjacent power source is unavailable. A convenient method of preheating a vehicle engine having a first battery, charged by an alternator comprising the steps of: providing for a second battery electrically charged by the alternator, said second battery electrically isolated from the first battery by a battery isolator, so that the first battery is not depleted by a load drawn from the second battery; and, providing an engine heater which draws power from the second battery. In a preferred aspect of this method the further steps of providing a thermostatic switch and a timer are included.

### FIELD OF THE INVENTION

This invention relates to engine heaters used for cold weather starting of motor vehicles. More particularly this invention relates to a thermostatically controlled and time programmed block heater which operates without the necessity of a power source adjacent to a parked vehicle.

### BACKGROUND OF THE INVENTION

After cold nights or during winter nights in cold climates vehicles start much more quickly and easily if they are pre-heated. Cranking a cold and unlubricated engine significantly wears and reduces the life of the engine. Furthermore, a pre-heated engine reaches operating temperature relatively quickly so that the interior passenger compartment of the vehicle can be defrosted and warmed. A pre-heated engine is a convenience which is much desired in cold weather.

One problem with preheating vehicles is that a cold morning must be anticipated so that the vehicle may be plugged in the preceding night. In very cold climates power is not available everywhere. The vehicle may be fully chilled after a day's work. Plugging the vehicle into a power source is not always possible and when it is possible, excessive energy may be dissipated if the vehicle is plugged in long before use.

### OBJECTS OF THE INVENTION

It is an object of this invention to provide more efficient starting and comfortable driving of motor vehicles in cold weather. It is an object of this invention to disclose a method of conveniently preheating an engine. It is yet a further object of this invention to disclose a method of efficiently preheating an engine immediately before use to conserve energy. It is a final object of this invention to eliminate the necessity of consistently anticipating cold weather and plugging in a vehicle to ensure that it is preheated for use.

One aspect of this invention provides for a method of preheating a vehicle engine having a first battery, charged by an alternator comprising the steps of: providing for a second battery electrically charged by the alternator, said second battery electrically isolated from the first battery by a battery isolator, so that the first battery is not depleted by a load drawn from the second battery; and, providing an engine heater which draws power from the second battery.

In a preferred aspect of this method the further steps of providing a thermostatic switch serially connected between the second battery and the engine heater so that the heater receives power only when ambient temperature drops below a specified temperature; and, the step of providing a timer serially connected between the second battery and the engine heater so that the engine heater is powered only at preset times programmed on the timer immediately in advance of use of the vehicle; are included.

In the most preferred aspect of this invention, the thermostatic switch and the timer are an integral unit. The engine heater is automatically powered on in advance of use times specified by the user on the timer, and the duration of these times in advance of use varies depending on the ambient temperature.

Various other objects, advantages and features of this invention will become apparent to those skilled in the art from the following description in conjunction with the accompanying drawings.

### FIGURES OF THE INVENTION

FIG. 1 is a diagrammatic view of a method of preheating a vehicle engine utilizing a second battery to power a vehicle heater.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

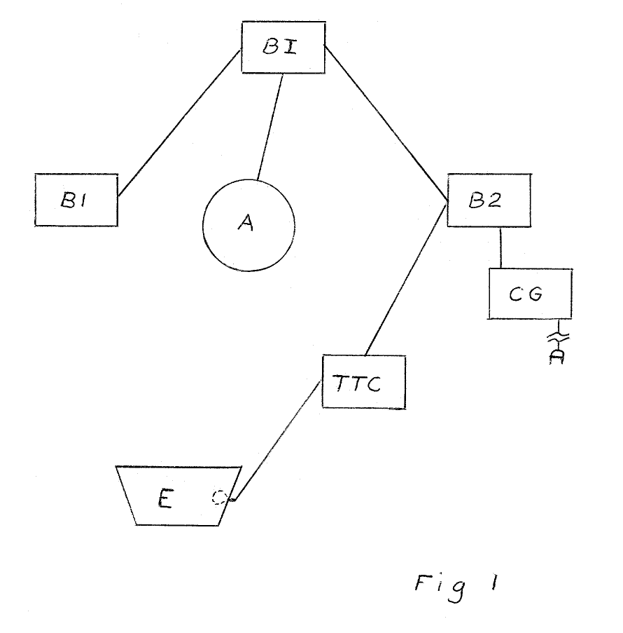

Turning now to the drawings and more particularly to FIG. 1 we have a diagrammatic view of a method of preheating a vehicle engine E utilizing a second battery B2 to power a vehicle heater 22. This method eliminates the necessity to anticipate and persistently plug into a power source adjacent to wherever the vehicle V may be parked. Most basically the method of preheating a vehicle engine E having a first battery B1 charged by an alternator A comprises the steps of: providing for a second battery B2 electrically also charged by the alternator A, said second battery B2 electrically isolated from the first battery B1 by a battery isolator BI, so that the first battery B1 is not depleted by a load drawn from the second battery B2; and, providing an engine heater 22 which draws power from the second battery B2.

A preferred aspect of this invention comprises a method as above further comprising the step of providing a thermostatic switch 26 serially connected between the second battery B2 and the engine heater 22 so that the heater 22 receives power only when the ambient temperature drops below a specified temperature. It is also preferable to additionally include the step of providing a timer 28 serially connected between the second battery B2 and the engine heater 22 so that the engine heater 22 is powered only at preset times programmed on the timer 26 immediately in advance of use of the vehicle V.

In the most preferred aspect of the invention, the thermostatic switch 26 and the timer 28 are an integral unit TTC. The engine heater 22 is powered in advance of use times specified by the user on the timer 26, and wherein the engine heater 22 is automatically programmed by the TTC to be powered on for varying amounts of time in advance of the specified times of use dependent on the ambient temperature.

Yet another aspect of this invention further comprises the step of providing a battery charger CG connected to the second battery B2 to facilitate charging the second battery B2 in periods of extended cold requiring relatively large amounts of preheating relative to alternator A charging. In the most preferred embodiment of this invention the engine heater 22 is a block heater 24 which is configured to operate on 12 VDC. When the block heater 24 is configured to operate directly on the direct current voltage produced by the second battery B2 the necessity of converting the power to 120 VAC, the requirement of conventional block heaters 24 is eliminated.

While the invention has been described with preferred specific embodiments thereof, it will be understood that this description is intended to illustrate and not to limit the scope of the invention, which is defined by the following claims.

I claim:

1) A method of preheating a vehicle engine having a first battery, charged by an alternator comprising the steps of:
providing for a second battery electrically charged by the alternator, said second battery electrically isolated from the first battery by a battery isolator, so that the first battery is not depleted by a load drawn from the second battery; and,
providing an engine heater which draws power from the second battery.

2) A method as in claim 1 further comprising the step of providing a thermostatic switch serially connected between the second battery and the engine heater so that the heater receives power only when ambient temperature drops below a specified temperature.

3) A method as in claim 2 further comprising the step of providing a timer serially connected between the second battery and the engine heater so that the engine heater is powered only at preset times programmed on the timer immediately in advance of use of the vehicle.

4) A method as in claim 3 wherein the thermostatic switch and the timer are an integral unit and wherein the engine heater is automatically powered on in advance of use times specified by the user on the timer, and wherein the the engine heater is automatically programmed to be powered on for varying amounts of time in advance of the specified times of use dependent on the ambient temperature.

5) A method as in claim 3 further comprising the step of providing a battery charger connected to the second battery to facilitate charging the second battery in periods of extended cold requiring relatively large amounts of preheating relative to alternator charging.

6) A method as in claim 1 wherein the engine heater is a block heater configured to operate on 12 VDC.
